(19) United States
(12) Patent Application Publication
(10) Pub. No.: US 2012/0234815 A1
(43) Pub. Date: Sep. 20, 2012

(54) TIME SENSITIVE HEATED SEAT CONTROL

(75) Inventors: Mark R. Willey, Grand Blanc, MI (US); Diane K. McQueen, Leonard, MI (US)

(73) Assignee: GM GLOBAL TECHNOLOGY OPERATIONS LLC, Detroit, MI (US)

(21) Appl. No.: 13/418,745

(22) Filed: Mar. 13, 2012

Related U.S. Application Data
(60) Provisional application No. 61/454,243, filed on Mar. 18, 2011.

(51) Int. Cl. B60N 2/56; H05B 1/02

(52) U.S. Cl. 219/202; 219/217; 219/492; 219/494

(57) ABSTRACT

A method and system for controlling a seat heater for a seat is provided. The method includes determining a timer value by a heated seat control module. The timer value is based on at least a current heater setting of the seat heater. The method includes sending the timer value to a timer. The timer counts down from the timer value and sends a timer expired signal to the heated seat control module if the amount of time indicated by the timer value has expired. The method includes determining a modified heater setting if the heated seat control module receives the time expired signal. The modified heater setting indicates a reduced level of heat provided to the seat heater. The method includes sending a notification signal to a signal generation module. The notification signal includes the modified heater setting.

### CROSS-REFERENCE TO RELATED APPLICATIONS

This patent application claims priority to U.S. Provisional Patent Application Ser. No. 61/454,243, filed Mar. 18, 2011, which is incorporated herein by reference in its entirety.

### FIELD OF THE INVENTION

Exemplary embodiments of the invention relate to a method and system of controlling a seat heater for a seat and, more particularly, to a method and system of controlling a seat heater by reducing a current heater setting to a modified heater setting.

### BACKGROUND

Seat heaters are provided in vehicle seats to heat the seats and to provide warmth to an occupant. Electrical energy is wasted when the seat heaters are left on for durations greater than required to warm the seats and/or occupant. Specifically, leaving the seat heaters on for a longer time than what is generally needed to heat the seats will in turn draw additional current, which in turn wastes energy. Accordingly, it is desirable to provide systems and methods for controlling the seat heater.

### SUMMARY OF THE INVENTION

In one exemplary embodiment, a method for controlling a seat heater for a seat is provided. The method includes determining a timer value by a heated seat control module. The timer value is based on at least a current heater setting of the seat heater. The method includes sending the timer value to a timer. The timer counts down from the timer value and sends a time expired signal to the heated seat control module if the amount of time indicated by the timer value has expired. The method includes determining a modified heater setting if the heated seat control module receives the time expired signal. The modified heater setting indicates a reduced level of heat provided to the seat heater. The method includes sending a notification signal to a signal generation module. The notification signal includes the modified heater setting. The method includes reducing the current heater setting to the modified heater setting.

In another embodiment, a control system for controlling a seat heater is provided. The seat heater has a current heater setting that indicates a current level of heat provided to the seat heater, and a modified heater setting that indicates a reduced level of heat provided to the seat heater. The control system includes a heated seat module, a timer, and a signal generation module. The heated seat control module determines a timer value, the modified heater setting and a notification signal. The timer value is based on at least the current heater setting of the seat heater. The timer is in communication with the heated seat module to receive the timer value. The timer counts down from the timer value and sends a time expired signal to the heated seat control module if the amount of time indicated by the timer value has expired. The signal generation module receives the notification signal from the heater seat control module. The notification signal includes the modified heater setting. The signal generation module produces a control signal to reduce the current heater setting to the modified heater setting.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a functional block diagram illustrating a vehicle that includes a control system for heating one or more vehicle seats in accordance with exemplary embodiments;

FIG. 2 is a dataflow diagram illustrating a control module of the control system in accordance with exemplary embodiments; and

FIG. 3 is flowchart illustrating an exemplary control method that can be performed by the control system in accordance with exemplary embodiments.

### DESCRIPTION OF THE EMBODIMENTS

The following description is merely exemplary in nature and is not intended to limit the present disclosure, its application or uses. As used herein the terms module and sub-module refer to an application specific integrated circuit (ASIC), an electronic circuit, a processor (shared, dedicated, or group) and memory that executes one or more software or firmware programs, a combinational logic circuit, and/or other suitable components that provide the described functionality.

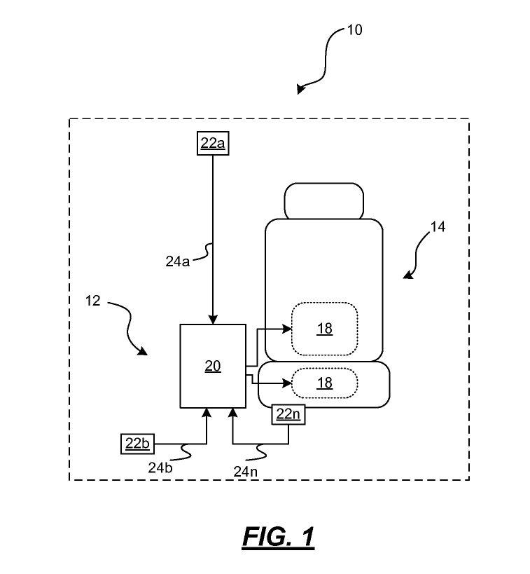

In accordance with exemplary embodiments, FIG. 1 is a schematic illustration of a vehicle 10 that includes a seat heater system shown generally at 12. The seat heater system 12 is associated with one or more seats 14 of the vehicle 10. The seat heater system 12 includes one or more seat heaters 18 disposed within the one or more seats 14 and a control module 20 that communicates with the seat heaters 18. In the embodiment as shown, the seat heaters 18 include adjustable levels of heat (e.g., for example, high, medium, or low). As can be appreciated, the seat heater system 12 of the present disclosure can be applicable to any seat and heater configuration in the vehicle 10 and is not limited to the present example.

As shown in FIG. 1, the vehicle 10 further includes various sensors 22a-22n that detect and measure observable conditions of the vehicle 10. The sensors 22a-22n generate sensor signals 24a-24n based on the observable conditions. In various embodiments, the sensors 22a-22n can include, for example, an ambient air temperature sensor, heater temperatures sensors, seat temperature sensors, or other vehicle temperature sensors. In one exemplary embodiment, the sensors 22a-22n may include, for example, an in-cabin temperature sensor of the vehicle 10 that is located within an instrument panel (not shown) of the vehicle 10. In another embodiment, the sensors 22a-22n may include a sensor that monitors a temperature of a top surface of the instrument panel (not shown).

The control module 20 processes one or more sensor signals 24a-24n from the various sensors 22a-22n and determines whether the temperature of the seat 14 should be limited and/or reduced. The control module 20 selectively limits or reduces the temperature by controlling or adjusting the level of heat of the seat heaters 18. In various embodiments, the control module 20 automatically adjusts the level of heat for the seat heaters 18 to account for temperature conditions of the vehicle 10 and the level of heat (e.g., high, medium or low) of the seat heaters 18. Specifically, the control module 20 commands, controls or selectively restricts the amount of electrical energy that may be supplied to the seat heaters 18.

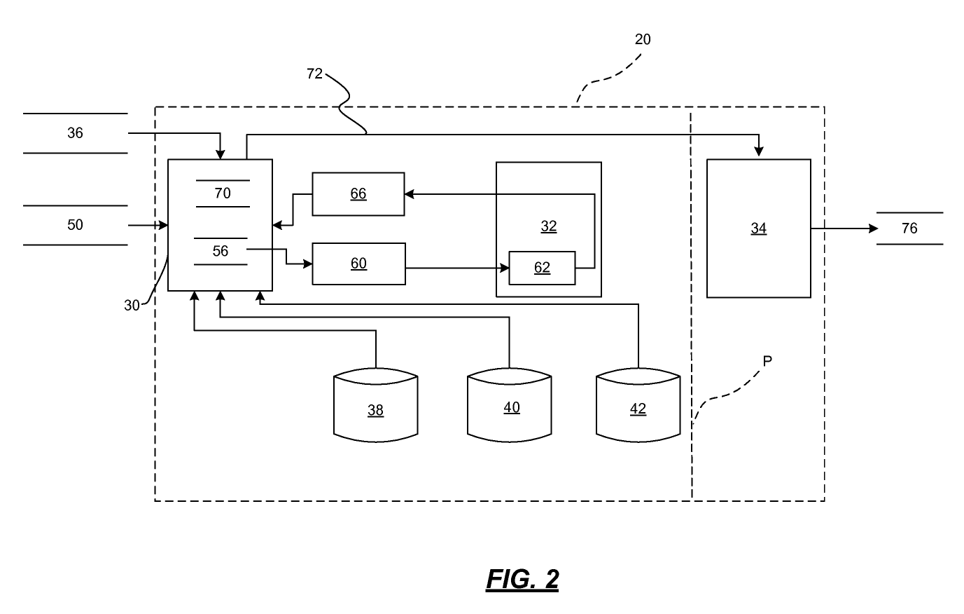

Referring now to FIG. 2, a dataflow diagram illustrates various embodiments of the control module 20 of FIG. 1. As can be appreciated, various embodiments of the control module 20 according to the present disclosure may include any number of sub-modules. As can be appreciated, the sub-modules shown in FIG. 2 may be combined and/or further partitioned to similarly control the temperature of the seat 14 (FIG. 1). Inputs to the control module 20 may be sensed directly from the vehicle 10 (FIG. 1), received from other modules within the vehicle 10 (FIG. 1), for example, via a vehicle communication network (not shown), and/or determined/modeled by other sub-modules (not shown) of the control module 20.

In various embodiments, the control module 20 includes a heated seat control module 30, a timer module 32, and a signal generation module 34. Although FIG. 2 illustrates the control module 20 including the signal generation module 34, in another embodiment the signal generation module 34 may be part of a separate physical control module (e.g., an output driver module), and is indicated by the phantom line P. The control module 20 generates control signals based on at least a current heater setting 36 of the seat 14 (shown in FIG. 1). In the exemplary embodiments discussed herein, the current heater setting 36 indicates a level of heat that is provided by the seat heaters 18 (FIG. 1). The current heater setting 36 may be one of a high setting, a medium setting, or a low setting. Respective datastores are provided for each of the high, medium and low settings, where a high datastore 38, a medium datastore 40, and a low datastore 42 are illustrated. Each of the datastores 38, 40, and 42 store predetermined time values that are associated with the current heater setting 36 (e.g., the high datastore 38 stores time values correlating to the high heater setting 36, the medium datastore 40 stores time values corresponding to the medium heater setting 36, and the low datastore 42 stores time values corresponding to the low heater setting 36). As can be appreciated, the current heater setting 36 can be any setting indicating a particular heat level or activation level and thus, the invention is not limited to the present examples.

With reference now to the exemplary embodiments of FIG. 2, the heated seat control module 30 receives as input at least one temperature value 50 as detected by one or more of the sensors 22a-22n (FIG. 1) and the current heater setting 36. It should be noted that while FIG. 2 illustrates both the temperature value 50 and the current heater setting 36 as inputs, in one embodiment the temperature value 50 may be omitted, and the current heater setting 36 is the only input to the heated seat control module 30. In one embodiment, the temperature value 50 may indicate an initial temperature of the seat 14 (shown in FIG. 1). Specifically, in one exemplary embodiment, one of the sensors 22a-22n (shown in FIG. 1) may be an in-cabin temperature sensor, or a sensor that monitors a temperature of a top surface of the instrument panel (not shown). The heated seat control module 30 (or another module or sub-module that is not illustrated) determines the temperature of the seat 14 based on the in-cabin temperature or the temperature of the top surface of the instrument panel. In another embodiment, one of the sensors 22a-22n (shown in FIG. 1) may be a seat temperature sensor that indicates the temperature of the seat 14.

The heated seat control module 30 determines a timer value 56 based on the inputs (e.g., the temperature value 50 and the current heater setting 36). The timer value 56 represents an amount of time that may elapse at an immediate or current value of the current heater setting 36 (e.g., the high setting, the medium setting, or the low setting) before the current heater setting 36 is automatically reduced to a lower setting. Specifically, the timer value 56 indicates a maximum amount of time that the current heater setting 36 is set to before the current heater setting 36 is automatically reduced to a lower setting (e.g., from the high setting to the medium setting, from the medium setting to the low setting, or from the low setting to the off setting). In another embodiment, the current heater setting 36 could also be reduced from the high setting to either the low setting or the off setting. For example, based on the temperature value 50 (e.g., the temperature of the seat 14) and the current heater setting 36 of the seat 14 (e.g., high, medium, or low), the heated seat control module 30 can set the timer value 56 to a predetermined value. The predetermined value can be accessed from a multi-dimensional table stored in one of the high datastore 38, the medium datastore 40, and the low datastore 42. The multi-dimensional table can be indexed by the temperature value 50.

In one embodiment, the timer value 56 may be either increased or decreased based on a nominal value (e.g., in one example the nominal value may be 30 minutes). For example, if the current heater setting 36 of the seat 14 is on the low setting, or if the seat 14 is at a relatively cooler temperature (e.g., below 20° C.), then the nominal value of the timer value 56 may be increased by an offset value. Likewise, in another example, if the current heater setting 36 of the seat 14 is at the high setting, or if the seat 14 is at a relatively warmer temperature (e.g., above 35° C.) the nominal value of the timer value 56 may be decreased by the offset value.

In another embodiment, the heated seat control module 30 adjusts the timer value 56 based on whether the seat heaters 18 (shown in FIG. 1) have previously been activated during a current drive cycle. For example, in one embodiment the seat heaters 18 (FIG. 1) may have been previously activated during the current drive cycle. However, the maximum amount of time that the current heater setting 36 may be set to had not expired (e.g., the seat heaters 18 were activated, but were then turned off or reduced by a user before being automatically adjusted to a lower setting). In this example, the heated seat control module 30 would reset the timer value 56 to the nominal value. In another example, if the seat heaters 18 had previously been activated during the current drive cycle, and if the maximum amount of time that the current heater setting 36 may be set to had expired, then the timer value 56 may be decreased by a predetermined value.

In the embodiment as shown, the heated seat control module 30 sends a start timer signal 60 to the timer module 32. The start timer signal 60 includes the timer value 56. In the embodiment as shown in FIG. 2, the timer module 32 includes a heating duration timer 62 that receives the start timer signal 60. The heating duration timer 62 counts down from the timer value 56. The timer module 32 manages the heating duration timer 62, and once the heating duration timer 62 has counted down to zero, this indicates that the amount of time indicated by the timer value 56 has expired. Thus, the heating duration timer 62 sends a time expired signal 66 to the heated seat control module 30. For example, if the timer value 56 is 30 minutes, then the heating duration timer 62 sends the time expired signal 66 once 30 minutes has elapsed.

The heated seat control module 30 determines a modified heater setting 70 if the time expired signal 66 is received from the timer module 32. The modified heater setting 70 represents a reduced or modified value that the current heater setting 36 should be reduced to. For example, in one embodiment if the current heater setting 36 is high, then the modified heater setting 70 would be one of medium, low or off depending on the inputs (e.g., the temperature value 50 and the current heater setting 36). If the current heater setting 36 is medium, then the modified heater setting 70 would be low. Likewise, if the current heater setting 36 is at low, then the modified heater setting 70 would be off.

The heated seat control module 30 is in communication with the signal generation module 34. The heated seat control module 30 sends a notification signal 72 to the signal generation module 34. The notification signal 72 includes the modified heater setting 70. The signal generation module 34 generates a control signal 76. The control signal 76 modifies the current heater setting 36 to the modified heater setting 70.

The seat heater system 12 as described above provides decreased electrical energy consumption. This is because the control module 20 automatically adjusts the temperature of the seat heaters 18 (FIG. 1) based on temperature and the current heater setting 36. Thus, the seat heaters 18 are generally not activated for a longer time than needed to heat the seats 14.

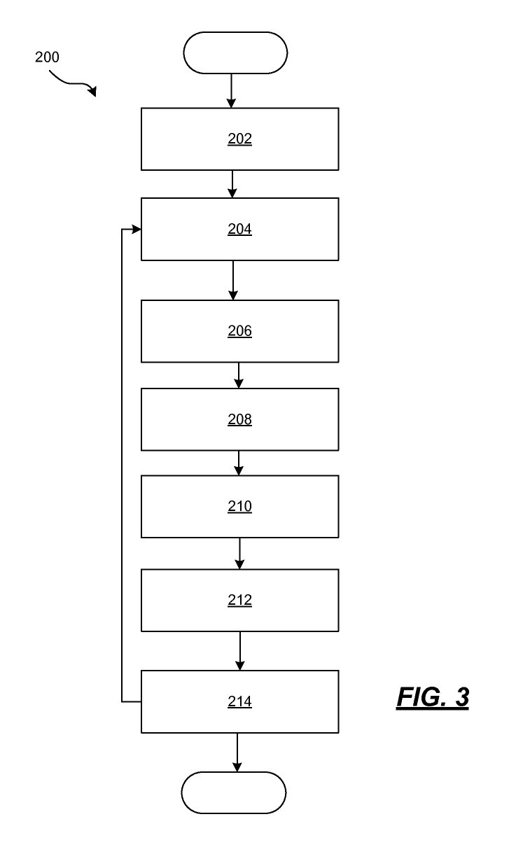

Referring now to FIG. 3, and with continued reference to FIGS. 1 and 2, a flowchart illustrates exemplary seat heater control methods that can be performed by the control module 20. As can be appreciated in light of the disclosure, the order of operation within the method is not limited to the sequential execution as illustrated in FIG. 3, but may be performed in one or more varying orders as applicable and in accordance with the present disclosure.

As can be appreciated, the seat heater control methods can be scheduled to run based on predetermined events and/or can run continually during operation of the vehicle 10 (FIG. 1) (as shown).

In one example, the method of FIG. 3 may be performed for each of the current heater settings 36 of the seat 14 (shown in FIG. 1) (e.g., for the low, the medium, and the high setting). Specifically, FIG. 3 illustrates a method 200 that begins at step 202, where the control module 20 evaluates whether a temperature limiting or reduction feature for the current heater setting 36 (shown in FIG. 2) is enabled or activated. If the temperature limiting feature is enabled, upon activation of the one or more seat heaters 18, method 200 may proceed to step 204.

In step 204, the timer value 56 is initialized. For example, if the seat heaters 18 had previously been activated during the current drive cycle, and if the maximum amount of time that the current value of the current heater setting 36 may be set to had not expired, the heated seat control module 30 subtracts the actual amount of time that elapsed during the current drive cycle with the seat heaters 18 activated from the timer value 56. In another example, if the seat heaters 18 had previously been activated during the current drive cycle, and if the maximum amount of time that the current value of the current heater setting 36 may be set to had expired, then the timer value 56 is set to zero. Method 200 may then proceed to step 206.

In step 206, the heated seat control module 30 sends the start timer signal 60 to the timer module 32. Specifically, as shown in FIG. 2, the heating duration timer 62 receives the start timer signal 60. Method 200 may then proceed to step 208.

In step 208, once the heating duration timer 62 has reached the amount of time as in indicated by the timer value 56, the heating duration timer 62 sends the time expired signal 66 to the heated seat control module 30. Method 200 may then proceed to step 210.

In step 210, the heated seat control module 30 determines the modified heater setting 70. Method 200 may then proceed to step 212.

In step 212, the heated seat control module 30 sends the notification signal 72 to the signal generation module 34. Method 200 may then proceed to step 214.

In step 214, signal generation module 34 generates the control signal 76. The control signal 76 modifies the current value of the current heater setting 36 to the modified heater setting 70 (e.g., if the current value of the current heater setting 36 is high, then the modified heater setting 70 would be one of medium low or off depending on the inputs (e.g., the temperature value 50 and the current heater setting 36), if the current heater setting 36 is medium, then the modified heater setting 70 would be low, and if the current value of the current heater setting 36 is low, then the modified heater setting 70 would be off). If the modified heater setting 70 is either medium or low, method 200 may proceed back to step 204. If the modified heater setting 70 is off, then method 200 may terminate.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method of controlling a seat heater for a seat, comprising:
determining a timer value by a heated seat control module, wherein the timer value is based on at least a current heater setting of the seat heater;
sending the timer value to a timer, wherein the timer counts down from the timer value and sends a time expired signal to the heated seat control module if the amount of time indicated by the timer value has expired;
determining a modified heater setting if the heated seat control module receives the time expired signal, the modified heater setting indicating a reduced level of heat provided to the seat heater;
sending a notification signal to a signal generation module, wherein the notification signal includes the modified heater setting; and
reducing the current heater setting to the modified heater setting.

2. The method as recited in claim 1, comprising providing one of a high setting, a medium setting, a low setting as the current heater setting.

3. The method as recited in claim 2, comprising providing a high datastore for storing time values correlating to the high setting, a medium datastore for storing time values corresponding to the medium setting, and a low datastore for storing time values corresponding to the low setting.

4. The method as recited in claim 2, comprising providing a medium modified setting, a low modified setting, and an off setting for the modified heater setting.

5. The method as recited in claim 4, comprising reducing the high setting to the medium modified setting, the medium setting to the low modified setting, and the low setting to the off setting.

6. The method as recited in claim 1, comprising setting the timer to a nominal value if the seat heater has previously been activated during a current drive cycle and if the time expired signal was not sent to the heated seat control module during the current drive cycle.

7. The method as recited in claim 1, comprising decreasing the timer value by a predetermined value if the seat heater has previously been activated during a current drive cycle and if the time expired signal was sent to the heated seat control module during the current drive cycle.

8. The method as recited in claim 1, wherein the timer value is further based on a temperature value.

9. The method as recited in claim 8, comprising one of increasing and decreasing the timer value by an offset value based on the temperature value and the current heater setting of the seat heater.

10. The method as recited in claim 8, wherein the temperature value indicates an initial seat temperature of the seat.

11. The method as recited in claim 8, wherein the temperature value is one of an in-cabin temperature and a temperature indicating a surface of an instrument panel, and wherein the heated seat control module includes control logic for determining an initial seat temperature of the seat based on the temperature value.

12. A control system for controlling a seat heater for a seat, the seat heater having a current heater setting that indicates a current level of heat provided to the seat heater and a modified heater setting that indicates a reduced level of heat selectively provided to the seat heater, comprising:
a heated seat control module that determines a timer value, the modified heater setting and a notification signal, wherein the timer value is based on at least the current heater setting of the seat heater;
a timer in communication with the heated seat module to receive the timer value, wherein the timer counts down from the timer value and sends a time expired signal to the heated seat control module if the amount of time indicated by the timer value has expired; and
a signal generation module for receiving the notification signal from the heater seat control module, the notification signal including the modified heater setting, wherein the signal generation module produces a control signal to reduce the current heater setting to the modified heater setting.

13. The control system as recited in claim 12, wherein the current heater setting is one of a high setting, a medium setting, a low setting.

14. The control system as recited in claim 12, wherein a high datastore is provided for storing time values correlating to the high setting, a medium datastore is provided for storing time values corresponding to the medium setting, and a low datastore is provided for storing time values corresponding to the low setting.

15. The control system as recited in claim 14, wherein a medium modified setting, a low modified setting, and an off setting are provided for the modified heater setting.

16. The control system as recited in claim 12, wherein the heated seat control module sets the timer value to a nominal value if the seat heater has previously been activated during a current drive cycle and if the time expired signal was not sent to the heated seat control module during the current drive cycle.

17. The control system as recited in claim 12, wherein the heated seat control module decreases the timer value by a predetermined value if the seat heater has previously been activated during a current drive cycle and if the time expired signal was sent to the heated seat control module during the current drive cycle.

18. The control system as recited in claim 12, wherein the timer value is further based on a temperature value, wherein the temperature value represents an initial temperature of the seat.

19. The control system as recited in claim 18, wherein the heated seat control module either increases or decreases the timer value by an offset value based on the temperature value and the current heater setting of the seat heater.

20. A control system, comprising:
a seat heater having a current heater setting that indicates a current level of heat provided to the seat heater, and a modified heater setting that indicates a reduced level of heat selectively provided to the seat heater; and
a control module in communication with the seat heater, the control module comprising:
a heated seat control module that determines a timer value, the modified heater setting and a notification signal, wherein the timer value is based on at least a temperature value and the current heater setting of the seat heater;
a timer in communication with the heated seat module to receive the timer value, wherein the timer counts down from the timer value and sends a time expired signal to the heated seat control module if the amount of time indicated by the timer value has expired; and
a signal generation module for receiving the notification signal from the heater seat control module, the notification signal including the modified heater setting, wherein the signal generation module produces a control signal to reduce the current heater setting to the modified heater setting.
